(19) United States
(12) Patent Application Publication
(10) Pub. No.: US 2005/0125275 A1
(43) Pub. Date: Jun. 9, 2005

(54) Method and system for measuring work productivity

(76) Inventors: Robert H. Wright, Ramsey, IN (US); Charles E. Raymond, Louisville, KY (US); Terry D. Thacker, Lawrenceburg, KY (US)

Correspondence Address: CANTOR COLBURN LLP, 55 GRIFFIN ROAD SOUTH, BLOOMFIELD, CT, 06002, US

(21) Appl. No.: 10/726,848

(22) Filed: Dec. 3, 2003

(51) Int. Cl. G06F 17/60

(52) U.S. Cl. 705/9

(57) ABSTRACT

A productivity measurement method and system in which work item status, exceptions, work item jeopardy and related information are automatically recorded and updated in a database in real-time as tasks are being performed. To-do lists are displayed on the worker's computer so that when the worker selects an item to begin working on it, an indication that the item has been selected is stored in an activities table in a database along with an indication of the time of the selection. As exceptions are encountered, the worker makes selections from the display to indicate that an exception has been encountered and the type of exception. An indication of the type of exception and the time that the exception selection was made are stored in the activities table. All of this activity information is automatically processed in real-time. Productivity reports can be automatically generated at any time from this information.

### TECHNICAL FIELD OF THE INVENTION

The present invention relates to telecommunications and, more particularly, to a method and system for measuring the productivity of individuals performing work assignments relating to telecommunications networks.

### BACKGROUND OF THE INVENTION

In telecommunications networks, setting up new client services is typically referred to as provisioning. The technicians that perform the tasks associated with provisioning new services each have a to-do list, which is a list of various tasks that are assigned to the technician. The technician selects items off of the to-do list and performs the tasks associated with the item. These items are grouped into tricks, which are then assigned to technicians. Each technician's to-do list contains items in the particular trick that has been assigned to the technician. The technicians perform the items on their to-do lists and fill out manual stroke sheets that identify the items that were completed during that day.

The information contained on the manual stroke sheets is helpful in measuring provisioning efficiency and productivity. Normally, once the technicians have filled out the manual stroke sheets, their supervisors manually enter the data contained on the sheets into a spreadsheet, which provides more detailed information than the WFA/DI system. The technicians also enter their task completion information into the WFA/DI database. The WFA/DI database compiles the data into one or more reports. These reports are used by provisioning supervisors and managers to evaluate provisioning productivity.

In addition to generating these reports, the WFA/DI database also generates to-do lists based on each technician's skills and time shift. When work orders are generated in response to requests received from customers, the work orders are entered by personnel into the WFA/DI database. WFA/DI also receives information from other systems via mechanized data feeds. The WFA/DI database compiles these work orders into the technicians' to-do lists. The to-do lists typically list items scheduled to be performed on particular dates over a particular period of time, such as a ninety-day period, for example. After items are completed, they are closed out in the WFA/DI database by a technician.

One disadvantage of the current technique is that it may take technicians longer to fill out the manual stroke sheets than to actually perform the provisioning tasks associated with an item on the to-do list. Also, because the manual stroke sheets are filled out after the provisioning task has been performed, events that occurred during the workday that may have delayed completion of a task may be forgotten. Therefore, a description of such events will not be included on the manual stroke sheets and therefore will not be contained in the WFA/DI database when reports are generated. Consequently, productivity assessments may be inaccurate.

Another disadvantage associated with the current technique is that it is difficult for supervisors to evaluate provisioning productivity from the raw text data contained in the reports. The reports generally only provide information that indicates how many tasks a technician completed during the work shift. Because there is a reasonable expectation of how much time each type of task should take to complete, the number and types of tasks performed during a given period of time provide some indication of productivity. However, problems that delayed completion of an item on the to-do list are not identified and therefore are not taken into account when the reports are generated. For example, supporting documentation for a particular item might contain errors that must be corrected before the technician can complete the tasks associated with the item. The time spent by the technician in having the documentation corrected currently is not taken into account in the WFA/DI reports. Hence, the cumbersome manual process has to be performed.

A need exists for a method and system for measuring work productivity that reduces the difficulties and time spent documenting completion of tasks, problems encountered in performing tasks, etc., and that increases the accuracy of productivity measurements.

### SUMMARY OF THE INVENTION

In accordance with the present invention, a productivity measurement method and system are provided in which work item status, exceptions, work item jeopardy and related information are automatically recorded and updated in a database in real-time as tasks are being performed. To-do lists are displayed on the worker's computer so that when the worker selects an item to begin working on it, an indication that the item has been selected is stored in an activities table in a database along with an indication of the time of the selection. As exceptions are encountered, the worker makes selections from the display to indicate that an exception has been encountered and the type of exception. An indication of the type of exception and the time that the exception selection was made are stored in the activities table. All of this activity information is automatically processed in real-time. Productivity reports can be automatically generated at any time from this information.

Work item status includes the time at which a worker, hereinafter referred to as a technician, begins working on a given item, whether or to what extent the item is complete and the time that the technician stopped working on the item. The term “exception”, as that term is used herein, is meant to denote any event that occurs while a technician is working on an item that diverts the technician away from working on the item for a period of time.

In accordance with embodiments of the invention, at the beginning of each workday, the technicians log into a web server that preferably uses the technician's Internet Protocol (IP) address to access the technician's to-do list. Therefore, in accordance with these embodiments, the system resides on server that is connected to a packet-based network that uses the Transmission Communication Protocol/Internet Protocol (TCP/IP) protocol. The network may be, for example, a wired or wireless local area network (LAN), a wide area network (WAN), the Internet, etc. In these embodiments, the technicians use their web browsers installed on their computers to access the web server, which then communicates the to-do list to their computers, which typically are personal computers (PCs). The browser displays the to-do list on the computer monitor as a window with buttons that can be clicked with a mouse to select items.

Because technicians normally perform provisioning tasks from PCs on the network, the present invention will be described with reference to technicians interacting with menus displayed on their PCs using their web browsers. However, the present invention is not limited to using any particular type of computer and does not have to be implemented as a windows-based type of system. The network also does not have to be a packet-based network. It should also be noted that although embodiments of the invention are being described with reference to telecommunications provisioning, the method and system of the invention are applicable to any type of work environment in any type of business.

When a technician accesses a to-do list by logging onto the web server, an administrative-time (admin) start time stamp is recorded in an activities table in the web server database. The web server database runs a script that automatically records the start time in the activities table. When the technician selects a particular item to work on by clicking on a work item identifier in the displayed window, the script causes a work item start time stamp to be automatically recorded in the activities table. When the technician selects a logoff button, the script causes work item and admin stop time stamps to be recorded in the activities table. In addition, the web server keeps track of the progress status of the work item and automatically records whether or to what extent the item has been completed.

When an exception occurs while a technician is logged into the web server and/or is working on an item, the technician selects an exception button in the displayed window. In response to making the selection, the script causes an exception start time stamp to be recorded and provides the technician with a drop down menu that lists exception options that can be selected. The options identify certain categories of exceptions. The technician selects the appropriate category and the web server records the selection. These categories are very helpful in measuring productivity because they identify whether or not the exception is work-related (e.g., a meeting, a training session, a call from home, etc.), whether the technician is encountering problems that affect overall provisioning productivity, such as errors in provisioning supporting documentation, for example, etc. This information provides an indication as to the technician's productivity, but also identifies problems or roadblocks that may affect overall provisioning productivity for all technicians on an ongoing basis. Once identified, these problems can be eliminated to improve overall provisioning productivity. If the exception button has been selected, the web server automatically records an exception stop time when the technician logs off of the system.

Because the web server records all of the above-described information in real-time, up-to-date provisioning information is constantly available from which productivity reports and updated to-do lists can be automatically compiled. Technicians and supervisors can use the constantly updated information to schedule provisioning services and to reschedule provisioning services that were previously scheduled but not completed. In other words, provisioning scheduling is made easier and more accurate because the continuously updated information provides for accurate forecasting. In addition, because the web server automatically records all of the work item information, administrative time information and exception information, it is not necessary for technicians or supervisors to spend time documenting this information afterwards. Thus, the tasks of preparing manual stroke sheets, spreadsheets, and entering information into the WFA/DI database are eliminated.

These and other features and advantages of the present invention will become apparent from the following description, drawings and claims.

### BRIEF DESCRIPTION OF THE DRAWINGS

FIG. 1 is a block diagram of the provisioning system in accordance with embodiments of the present invention.

FIG. 2 is a screen shot of a to-do list that is automatically displayed to a technician upon logging into the provisioning system shown in FIG. 1.

FIG. 3 is a screen shot of a window that is displayed to a technician when the technician selects an item off of the to-do list shown in FIG. 2.

FIG. 4 is a flow chart illustrating the method performed by the system shown in FIG. 1.

### DETAILED DESCRIPTION OF THE INVENTION

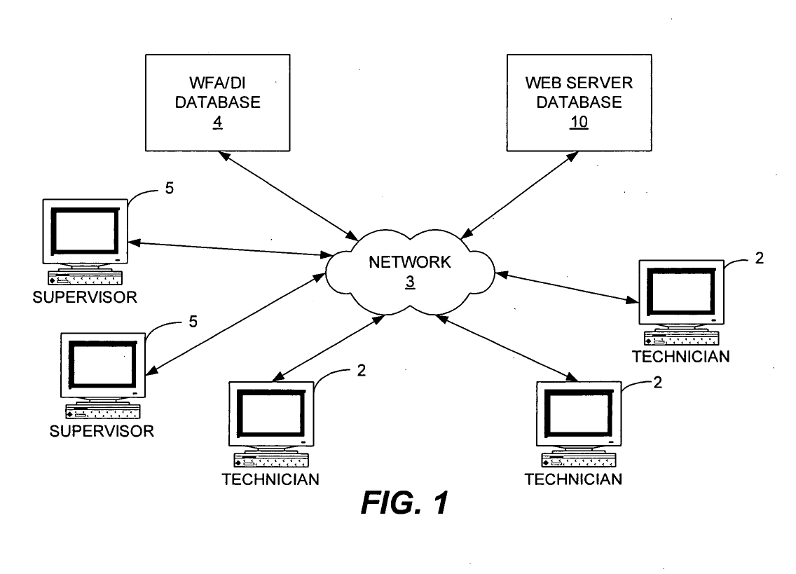

FIG. 1 is a block diagram of the system 1 in accordance with embodiments of the invention. In accordance with these embodiments, a technician uses a web browser installed on the technician's PC 2 to access the web server database 10 over a network 3, which may be a wired or wireless LAN, WAN, the Internet, or a combination of any two or more of these networks, for example. The aforementioned WFA/DI database 4 is also connected to the network 3. Embodiments of the invention leverage the capability of the WFA/DI database 4 that is currently used to generate to-do lists and productivity and other types of reports. The technicians 2 typically entered the information into the WFA/DI database 4 and the WFA/DI database 4 typically generates the to-do lists at such a time that they are ready to be picked up by the technicians at the beginning of the work shift.

In accordance with these embodiments, the records contained in the aforementioned activities table of the web server database 10 are periodically communicated over the network 3 and loaded into the WFA/DI database 4, thereby eliminating the need for stroke sheets and for supervisors to enter this information into the WFA/DI database 4. The WFA/DI database 4 compiles this information into to-do lists that are then communicated over the network 3 and loaded into the web server database 10 so that the technicians can access them from their PCs 2 using their web browsers. As described above, information relating to the to-do lists is generated and updated in real time and stored in activities tables on the web server database 10.

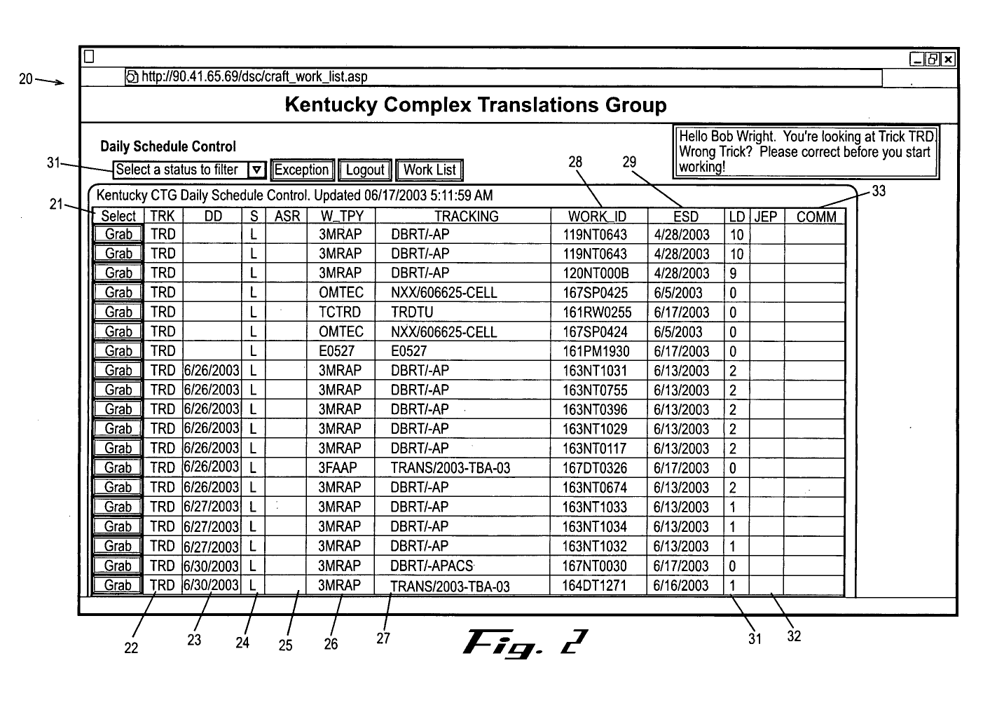

FIG. 2 is an example of a screen shot that is displayed to a technician on the PC monitor when the technician logs into the web server 10. The screen shot 20 is an example of a typical to-do list for a technician whose assigned trick is “TRD”. The to-do list has several columns that provide the technician with information that helps the technician understand the to-do list. The “Select” column 21 contains the word “Grab” beside each work item. As described below in more detail, when a technician wants to work on a particular item listed in the to-do list, the technician clicks on the Grab button beside that item. The “TRK” column 22 lists initials that identify the trick contained in the to-do list displayed in the screen shot 20. When the WFA/DI database 4 generates the to-do lists, it only loads the items that it determines have the potential of being completed that day. Consequently, only those items are displayed in the to-do list. The other items are hidden from the technician, although the technician can view them if desired by making a selection from the menu.

The “S” column 24 identifies the status of the items. All of the entries in that column are “L”, which indicates that those items have been “loaded” by the WFA/DI database 4 into the to-do list. The browser has the capability of displaying all of the items that need to be performed over a longer period of time than the current workday (e.g., the next 90 days), but because these items likely cannot be performed during the current workday, it was deemed unnecessary to show all of the items. If the technician uses the status filter 31 to change the status to “W” (“waiting” to be loaded), items that have not yet been loaded into the to-do list will be displayed. The filter 31 can be used to cause various configurations of the to-do list to be displayed.

The “DD” column 23 indicates the due date for each item. If the due dates are after the current date, they are blocked out in the to-do list for the current day. The “ASR” column 25 lists access service requests associated with each item, which identify someone outside of network 3 who is requesting access to the network 3. The “W_Type” column 26 identifies the work type for each item. The “TRACKING” column 27 identifies tracking keys that describe the items in more detail. The entries in the “Work_ID” column 28 are numbers that would be used to access additional information about the associated item. The “ESD” column 29 lists early start dates for the item. This date corresponds to the earliest date on which the item should be provisioned. For example, if a provisioning service has been ordered, but will not need to be performed for several months, the earliest start date will be the earliest date on which that service actually needs to be provided.

The “LD” column 31 lists the number of times the item has been loaded into the technicians the to-do list. The “JEP” column 32 indicates whether or not jeopardy has been declared for the associated item. Jeopardy, as that term is used herein, means that a problem or error has been encountered that has prevented the item from being worked on or completed. For example, if the supporting documentation that is needed to perform the provisioning task has errors in it, a jeopardy code describing the type of jeopardy problem will be contained in the JEP column 32 in the row that contains the corresponding item. The “COMM” column 33 lists comments that were previously entered by a technician relating to the item. For example, if a technician who previously worked on the item encountered a roadblock that placed the item in jeopardy, the technician will have been provided the opportunity to enter comments that will be stored as a record associated with the item in the web server database 10.

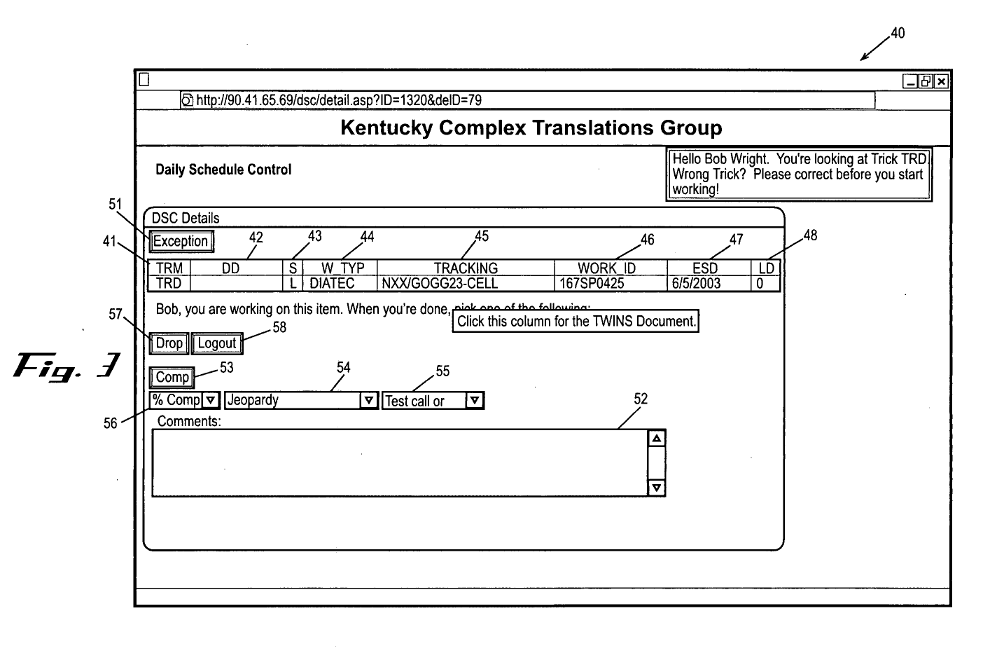

To select one of the items on the to-do list, the technician clicks on the associated Grab button in the Select column 21. When that happens, the web server 10 displays the window 40 shown in FIG. 3. The window 40 shown in FIG. 3 corresponds to the item that has work ID number 167SP0425 in row 34 of the window 20 shown in FIG. 2. The columns in FIG. 3 labeled TRK, DD, S. W_TYP, TRACKING, WORK_ID, ESD and LD serve the same purposes as the like-named columns in FIG. 2. As indicated above, when an item is selected, or grabbed, an item start time stamp associated with this item is recorded in the activities table in the web server database 10. For purposes of providing an example of the manner in which exceptions are handled by the provisioning system, it will be assumed that after grabbing the item, the technician handling the item noticed an error in the provisioning supporting documentation. Upon noticing the error, the technician clicks on the exception button 51 shown in FIG. 3, which causes a drop-down menu (not shown) to be displayed in window 40.

In accordance with the preferred embodiment, in order to standardize the reporting and characterization of exceptions, several types of exceptions are displayed in a drop-down menu, including telephone calls, trouble ticket, provisioning-item-not-on-to-do list, project, item time, meetings and training. There is no limitation as to the type or number of exceptions that may be included in the drop-down menu. The drop-down menu preferably will show at least these categories, and once the technician selects the appropriate category, other drop down boxes will be displayed by category type to provide the technician with the opportunity to make a selection that further describes the exception.

In this example, when the technician notices an error in the provisioning supporting documentation, the technician clicks on the trouble ticket drop-down box (not shown) and several types of trouble ticket exceptions will be displayed to provide the technician with the opportunity to click on the trouble ticket exception that most closely, or precisely, describes the error in the trouble ticket. As stated above, in the embodiments being described, start and stop time stamps associated with the exception will be recorded in the activities table in the web server database 10.

The exception will last until the problem has been solved or the technician determines that the problem cannot be solved that particular day. If the technician is able to handle the exception that day, the technician will do so and then click the logout button 58 when the exception is complete. The web server will then record the exception stop time stamp. If the exception presents problems that cannot be solved that day, the technician will click the drop selection 54, which will cause the window 20 shown in FIG. 2 to be re-displayed. If the exception has placed the item in jeopardy, the technician selects the corresponding jeopardy code from the drop-down box 54. The technician may also enter comments in the comment box 52 to further elaborate on the circumstances surrounding the exception or to further identify what placed the item in jeopardy.

If no exceptions occur after the technician grabs the item, the technician will perform the item and click the complete button 53 when finished. A drop-down box 56 allows the technician to indicate the degree to which the provisioning job is complete. If the job is 100% complete, the technician selects the corresponding item from the drop-down menu. If the job is 100% complete, often the technician will perform a test call or somehow verify that the job was successfully completed. The drop-down box 55 provides the technician with the option of indicating whether or not a test was performed. If the technician is going to logout before the job is 100% complete, the technician selects the percentage of completeness of the job using the drop-down box 56 and then logs out by clicking the logout button 58.

As stated above, the provisioning activity is recorded in real time in the web server database 10. When the technicians' work shift is over, the provisioning data stored in the web server database 10 is downloaded to the WFA/DI database 4, although the invention is not limited with respect to how often the WFA/DI database 4 can be updated with the data from the web server database 10. Also, as stated above, it is not necessary to use the WFA/DI database 4. Once the data is contained in the WFA/DI database 4, provisioning reports of various types can be generated from the data by the WFA/DI database 4. In accordance with embodiments of the invention, the time stamps, item completion data and exception data are used by a program executed by the WFA/DI database 4 to generate the provisioning productivity reports. However, the invention is not limited with respect to the type of information that can be used by the program to generate the reports. It should also be noted that the invention is not limited with respect to the machine that generates the reports. For example, the web server database 10 could also be programmed to generate these reports.

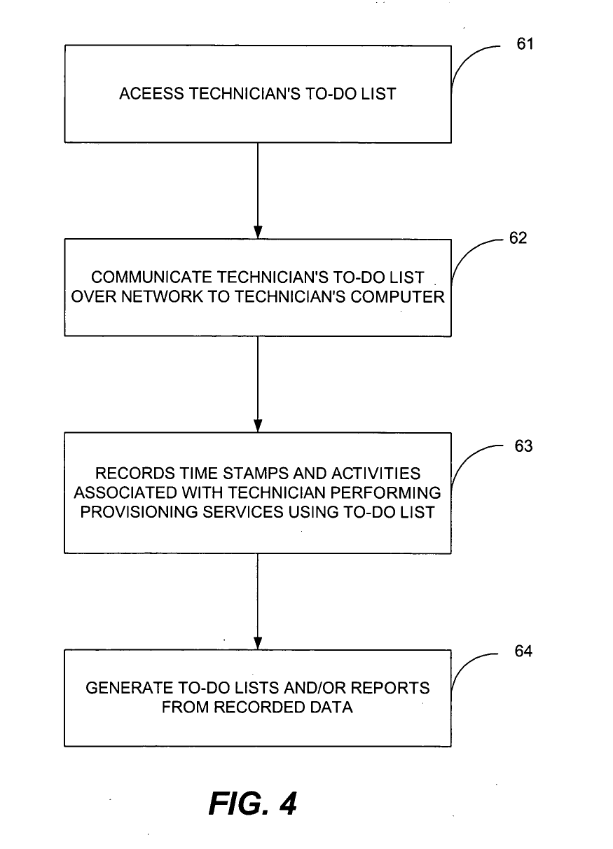

FIG. 4 is a flow chart of the method performed by the system shown in FIG. 1 in accordance with embodiments of the invention. When a technician logs into the web server 10 using a web browser, the web server accesses the technician's to-do list, which has been generated by the WFA/DI database 4, the web server database 10, or some other machine. As stated above, in accordance with embodiments of the invention, the to-do lists are generated by the WFA/DI database 4 and communicated to the web server database 10 via the network 3. The step of accessing the technician's to-do list is represented by block 61. The to-list is then communicated to the technician's computer and displayed on the monitor, as indicated by block 62. As the technician performs items, records exceptions, comments, item completion percentages, etc., the web server database 10 records the associated time stamps and activity, as indicated by block 63. Subsequently, to-do lists and reports, including provisioning productivity reports, may be compiled from the recorded data, as indicated by block 64.

It should be noted that the invention has been described with reference to certain embodiments and that the invention is not limited to these embodiments. For example, certain aspects of the invention have been described with reference to the WFA/DI database 4 because of the desire to leverage existing uses of this database. However, the functions described as being performed by the WFA/DI database 4 could instead be performed by the web server database 10 or by some other machine. It should also be noted that the information contained in the to-do lists and the format of the to-do lists can be different from what is shown and described herein. FIGS. 2 and 3 merely demonstrate examples of possible to-do lists.

Furthermore, although the invention has been described with respect to provisioning new services, the present invention also applies to maintaining existing services. For example, the to-do list shown in FIG. 2 could be a list of repairs to be performed for existing subscribers. It should also be noted that while the invention has been described with reference to telecommunications services, the invention is equally applicable to other industries in which jobs that need to be performed are scheduled. Activities that occur during the performance of those jobs, including exceptions, and time stamps can be recorded and used to organize the work loads and generate reports, including productivity reports. Those skilled in the art will understand that other modifications can be made to the embodiments described herein and that all such modifications are within the scope of the invention.

1. A system for measuring work productivity comprising:
an activities-recording computer;
a first memory device in communication with the activities-recording computer, the first memory device having at least a first to-do list stored therein;
at least a first technician computer in communication with the activities-recording computer, the first technician computer being operated by a first technician;
at least a first display monitor connected to the first technician computer;
at least a first input device connected to the first technician computer;
and wherein the activities computer retrieves the first to-do list from the first memory device and sends it to the first technician computer, the first technician computer causing the first to-do list to be displayed on the first display monitor, and wherein if the first technician selects an item on the displayed to-do list with the input device, the first technician computer sends an indication of the selection to the activities-recording computer and the activities-recording computer causes the indication to be stored in the first memory device.

2. The system of claim 1, further comprising a network, the activities-recording computer and the first technician computer being connected to the network and being in communication with each other via the network.

3. The system of claim 2, wherein the activities-recording computer is a web server and wherein the first technician computer runs a web browser program that displays the first to-do list in a window on the first display monitor.

4. The system of claim 3, wherein the network is an intranet that uses a Transmission Control Protocol/Internet Protocol (TCP/IP) to transmit packets to IP addresses on the network.

5. The system of claim 3, wherein the network is a local area network (LAN).

6. The system of claim 3, wherein the network is a wide area network (WAN).

7. The system of claim 3, wherein the network is the Internet.

8. The system of claim 1, wherein if an item on the first to-do list is selected with the input device, a start time indication associated with the selected item is stored by the activities-recording computer along with the indication of the selection in the first memory device.

9. The system of claim 1, wherein if after an item is selected on the to-do list, a logoff option displayed on the first display monitor is selected with the first input device, the activities-recording computer stores a stop time indication associated with the item selected from the to-do list in the first memory device.

10. The system of claim 9, wherein if after an item on the to-do list is selected, an exception option displayed on the first display monitor is selected with the first input device, the activities-recording computer stores an exception start time indication in the first memory device.

11. The system of claim 10, wherein if after an item on the to-do list is selected, a jeopardy option displayed on the first display monitor is selected, the activities-recording computer stores a jeopardy identifier in the first memory device.

12. A method for measuring work productivity comprising:
storing a first to-do list in a first memory device, the first to-do list including a listing of work items that need to be performed; and
with an activities-recording computer, retrieving the first to-do list from the first memory device and sending the first to-do list to a first technician computer that causes the first to-do list to be displayed on a first display monitor connected to the first technician computer.

13. The method of claim 12, wherein the activities-recording computer and the first technician computer are connected to a network and are in communication with each other via the network.

14. The method of claim 13, wherein the activities-recording computer is a web server and wherein the first technician computer runs a web browser program that displays the first to-do list in a window on the first display monitor.

15. The method of claim 14, wherein the network is an intranet that uses a Transmission Control Protocol/Internet Protocol (TCP/IP) to transmit packets to IP addresses on the network.

16. The method of claim 14, wherein the network is a local area network (LAN).

17. The method of claim 14, wherein the network is a wide area network (WAN).

18. The method of claim 14, wherein the network is the Internet.

19. The method of claim 12, further comprising:
in the activities-recording computer, receiving an indication that an item in the to-do list has been selected; and
storing the indication of the selection in the first memory device.

20. The method of claim 19, further comprising:
with the activities-recording computer, storing a start time indication associated with the selected item in the first memory device.

21. The method of claim 20, further comprising:
in the activities-recording computer, receiving an indication that a logoff option displayed on the first display monitor has been selected; and
with the activities-recording computer, when the indication of the logoff option selection is received, storing a stop time indication in the memory device.

22. The method of claim 21, further comprising:
in the activities-recording computer, receiving an indication that a selection option displayed on the first display monitor has been selected; and
with the activities-recording computer, when the indication of the exception option selection is received, storing an exception start time indication the memory device.

23. The method of claim 22, further comprising:
in the activities-recording computer, receiving an indication that a jeopardy option displayed on the first display monitor has been selected; and
with the activities-recording computer, when the indication of the jeopardy selection option is received, storing a jeopardy identifier in the memory device.

24. A computer program for measuring work productivity, the program being embodied on a computer-readable medium, the program comprising:
a first code segment for storing a first to-do list in a first memory device; and
a second code segment for retrieving the first to-do list from the first memory device and initiating sending of the first to-do list to a first technician computer.

25. The computer program of claim 24, further comprising:
a third code segment for recording activity data in a first memory device, the activity data being generated by a first technician computer in response to a technician selecting items from a to-do list displayed on a display monitor with an input device connected to the first technician computer.

26. The computer program of claim 25, wherein when an item on the to-do list is selected with the input device, the third code segment causes an indication of the selected item and a start time indication associated with the selected item to be stored and in the first memory device as activity data.

27. The computer program of claim 26, wherein if after the selection of the item on the to-do list is made, a logoff option displayed on the first display monitor is selected with the first input device, the third code segment causes a stop time indication associated with the selected item to be stored in the first memory device.

28. The computer program of claim 27, wherein if after the selection of the item on the to-do list is made, an exception option displayed on the first display monitor is selected with the first input device, the third code segment causes an exception start time indication to be stored in the first memory device.

29. The computer program of claim 28, wherein if after the selection of the item on the to-do list is made, a jeopardy option displayed on the first display monitor is selected with the first input device, the third code segment causes a jeopardy identifier to be stored in the first memory device.
